(19) United States
(12) Patent Application Publication
(10) Pub. No.: US 2020/0094623 A1
(43) Pub. Date: Mar. 26, 2020

(54) TIRE WITH TREAD

(71) Applicant: The Goodyear Tire & Rubber Company, Akron, OH (US)

(72) Inventors: Nihat Ali Isitman, Hudson, OH (US); Paul Harry Sandstrom, Cuyahoga Falls, OH (US); Teresa Diane Martter, Akron, OH (US); Aaron Patrick Murray, Chardon, OH (US)

(21) Appl. No.: 16/512,435

(22) Filed: Jul. 16, 2019

Related U.S. Application Data
(60) Provisional application No. 62/734,419, filed on Sep. 21, 2018.

(51) Int. Cl. B60C 1/00; C08L 9/00; C08K 5/548; C08K 3/04; C08K 3/36; C08F 236/06; C08F 236/08; C08K 5/11; C08K 5/09

(52) U.S. Cl. CPC B60C 1/0016; C08L 9/00; C08K 5/548; C08K 3/04; C08K 5/09; C08F 236/06; C08F 236/08; C08K 5/11; C08K 3/36

(57) ABSTRACT

This invention relates to a tire with a tread of a rubber composition containing a combination of high and low glass transition temperature (Tg) synthetic elastomers. The high Tg elastomer is comprised of a high Tg, high vinyl content, functionalized polybutadiene rubber and the low Tg elastomer is comprised of a low Tg, low vinyl content, functionalized polybutadiene rubber. The tread rubber may contain traction resins, may contain rosin acid and may contain triglyceride vegetable rubber processing oil.

### FIELD OF THE INVENTION

This invention relates to a tire with a tread of a rubber composition containing a combination of high and low glass transition temperature (Tg) synthetic elastomers. The high Tg elastomer is comprised of a high Tg, high vinyl content, functionalized polybutadiene rubber and the low Tg elastomer is comprised of a low Tg, low vinyl content, functionalized polybutadiene rubber. The tread rubber may contain traction resins, may contain rosin acid and may contain triglyceride vegetable rubber processing oil.

### BACKGROUND OF THE INVENTION

Tires are sometimes desired with treads for promoting traction on wet surfaces. Various rubber compositions may be proposed for such tire treads.

For example, tire tread rubber compositions which contain high molecular weight, high Tg (high glass transition temperature) diene based synthetic elastomer(s) might be desired for such purpose particularly for wet traction (traction of tire treads on wet road surfaces). Such tire tread may be desired where its reinforcing filler is primarily precipitated silica with its reinforcing filler therefore considered as being precipitated silica rich insofar as its reinforcing filler is concerned.

In one embodiment, the improved predictive wet traction performance for the tread rubber composition is based on a relative maximization of its tan delta physical property at 0° C.

However, it is also desired to provide such tread rubber composition containing the high Tg elastomer for wet traction with a lower stiffness at lower temperatures to promote cold weather winter performance, particularly for vehicular snow driving.

In one embodiment, the predictive cold weather performance for the tread rubber composition is based on its stiffness physical property at −20° C. as a measure of indication of such predictive cold weather performance (e.g. stiffness property such as storage modulus E′).

Therefore, it is desirable to provide such vehicular tread with a rubber composition containing both high and low Tg polybutadiene elastomers with a relatively optimized (relatively maximized) tan delta property at 0° C. (for predictive wet traction performance improvement) combined with a relatively optimized (relatively minimized) stiffness property at −20° C. (for predictive cold weather performance improvement).

Historically, a tire tread has been proposed for a combination of wet traction and cold weather performance containing a combination of high Tg, high vinyl polybutadiene rubber and low Tg, low vinyl polybutadiene rubber. For Example, see U.S. Pat. No. 9,441,098.

Here, it is proposed to evaluate use of a precipitated silica reinforced tread rubber composition for such purpose containing a combination of functionalized high Tg high vinyl content polybutadiene rubber and functionalized low Tg low vinyl content polybutadiene rubber which contain functional groups reactive with hydroxyl groups contained on said precipitated silica reinforcing filler.

In the description of this invention, the terms “compounded” rubber compositions and “compounds” are used to refer to rubber compositions which have been compounded, or blended, with appropriate rubber compounding ingredients. The terms “rubber” and “elastomer” may be used interchangeably unless otherwise indicated. The amounts of materials are usually expressed in parts of material per 100 parts of rubber by weight (phr).

The glass transition temperature (Tg) of the elastomers may be determined by DSC (differential scanning calorimetry) measurements at a temperature rising rate of about 10° C. per minute, as would be understood and well known by one having skill in such art. The softening point of a resin may be determined by ASTM E28 which might sometimes be referred to as a ring and ball softening point.

### SUMMARY AND PRACTICE OF THE INVENTION

In accordance with this invention, a pneumatic tire is provided having a circumferential rubber tread intended to be ground-contacting, where said tread is a rubber composition containing precipitated silica reinforcement comprised of, based on parts by weight per 100 parts by weight elastomer (phr):

(A) 100 phr of conjugated diene-based elastomers comprised of;
(1) about 20 to about 80, alternately about 25 to about 75 , phr of a functionalized high Tg, high vinyl polybutadiene rubber having a Tg in a range of from about −40° C. to about −10° C. and an isomeric vinyl 1,2-content in a range of from about 65 to about 85 percent, where said functionalized high vinyl polybutadiene rubber contains functional groups reactive with hydroxyl groups on said precipitated silica reinforcement,
(2) about 80 to about 20, alternately about 75 to about 25 , phr of a functionalized low Tg, low vinyl polybutadiene rubber having a Tg in a range of from about −108° C. to about −90° C. and an isomeric vinyl 1,2-content in a range of from about zero to about 15 percent, where said functionalized low vinyl polybutadiene rubber contains functional groups reactive with hydroxyl groups on said precipitated silica reinforcement,
provided that the weight ratio of low vinyl to high vinyl functionalized polybutadiene rubber is at least 1/1 and alternately at least 1.5/1,

(B) about 60 to about 200, alternately from about 80 to about 160, phr of rubber reinforcing filler comprised of a combination of precipitated silica (amorphous synthetic precipitated silica) and rubber reinforcing carbon black in a weight ratio of precipitated silica to rubber reinforcing carbon black of at least 9/1, together with a silica coupling agent having a moiety reactive with hydroxyl groups (e.g. silanol groups) on said precipitated silica and another different moiety interactive with said diene-based elastomers, and

(C) zero to about 60, alternately from about 5 to about 40, phr of a traction promoting resin (e.g. traction between said tread and ground) comprised of at least one of styrene-alphamethylstyrene resin, coumarone-indene resin, petroleum hydrocarbon resin, terpene polymer, terpene phenol resin, rosin derived resin and copolymers wherein such resins may have various softening points (ASTM E28) such as, for example, within a range of from about 60° C. to about 150° C.

In one embodiment, said functional high vinyl containing polybutadiene elastomers are end-functionalized with at least one functional group reactive with hydroxyl groups on said precipitated silica.

In one embodiment, said functionalized high and low vinyl polybutadiene elastomers are end-functionalized during an anionic polymerization of 1,3-butadiene monomer by use of a functionalized polymerization initiator. Such functionalization may be referred to herein as a pre-end functionalization of the elastomer and thereby a pre-end functionalized elastomer.

In another embodiment, said functionalized high and low vinyl polybutadiene elastomers are end-functionalized during the polymerization of 1,3-butadiene monomer by use of a functionalized polymerization terminator. Such functionalization is referred to herein as a post-end functionalization of the elastomer and thereby a post-end functionalized elastomer.

In a further embodiment, said functionalized high and low vinyl polybutadiene elastomers are bi-end functionalized during the polymerization of 1,3-butadiene monomer by use of a combination of functionalized polymerization initiator and functionalized polymerization terminator. Such dual functionalization may be referred to herein as the reaction product of a living anionic elastomeric high vinyl polybutadiene where the polymerization of the 1,3-butadiene monomer is initiated with a functional polymerization initiator and the polymerization is terminated with a functional polymerization terminator.

In one embodiment, said functional high and low vinyl polybutadiene elastomers contain at least one functional group reactive with hydroxyl groups on said precipitated silica comprised of:

(A) Amine functional group reactive with hydroxyl groups on said precipitated silica,

(B) Siloxy functional group reactive with hydroxyl groups on said precipitated silica,

(C) Combination of amine and siloxy groups reactive with hydroxyl groups on said precipitated silica,

(D) Combination of siloxy and thiol groups reactive with hydroxyl groups on said precipitated silica,

(E) Combination of imine and siloxy groups reactive with hydroxyl groups on said precipitated silica,

(F) Hydroxyl functional groups reactive with said precipitated silica,

(G) Epoxy groups reactive with hydroxyl groups on said precipitated silica,

(H) Carboxyl groups reactive with hydroxyl groups on said precipitated silica, and

(I) Alkyl or Aryl silylamine groups reactive with hydroxyl groups on said precipitated silica.

In additional accordance with this invention, said tread rubber composition is exclusive of styrene containing elastomers.

In further accordance with this invention, said tire tread is provided as a sulfur cured rubber composition.

In one embodiment said tread rubber composition further contains up to 25, alternately up to about 15, phr of at least one additional diene based elastomer exclusive of styrene containing elastomers. Such additional elastomer may be comprised of, for example, at least one of cis 1,4-polyisoprene rubber (natural rubber or synthetic rubber), and copolymers of isoprene and butadiene.

In one embodiment, said precipitated silica and silica coupling agent may be pre-reacted to form a composite thereof prior to their addition to the rubber composition.

In one embodiment, said precipitated silica and silica coupling agent may be added to the rubber composition and reacted together in situ within the rubber composition.

In one embodiment, the rubber composition contains traction promoting resin desirably comprised of at least one of styrene/alphamethylstyrene resin, coumarone-indene resin, petroleum hydrocarbon resin, terpene polymer, terpene phenol resin and rosin derived resin, copolymers thereof and hydrogenated rosin acid.

In one embodiment, the resin is a styrene/alphamethylstyrene resin. Such styrene/alphamethylstyrene resin may be, for example, a relatively short chain copolymer of styrene and alphamethylstyrene. In one embodiment, such a resin may be suitably prepared, for example, by cationic copolymerization of styrene and alphamethylstyrene in a hydrocarbon solvent. The styrene/alphamethylstyrene resin may have, for example, a styrene content in a range of from about 10 to about 90 percent. The styrene/alphamethylstyrene resin may have a softening point, for example, in a range of from about 60° C. to about 125° C., alternately from about 80° C. to 90° C. (ASTM E28). A suitable styrene/alphamethylstyrene resin may be, for example, Resin ²³³⁶ ™ from Eastman or Sylvares SA85™ from Arizona Chemical.

In one embodiment, the resin is a coumarone-indene resin. Such coumarone-indene resin may have a softening point, for example, in a range of from about 60° C. to about 150° C. containing coumarone and indene as the monomer components making up the resin skeleton (main chain). Minor amounts of monomers other than coumarone and indene may be incorporated into the skeleton such as, for example, methyl coumarone, styrene, alphamethylstyrene, methylindene, vinyltoluene, dicyclopentadiene, cycopentadiene, and diolefins such as isoprene and piperlyene.

In one embodiment, the resin is a petroleum hydrocarbon resin. Such petroleum hydrocarbon resin may be, for example, an aromatic and/or nonaromatic (e.g. paraffinic) based resin. Various petroleum resins are available. Some petroleum hydrocarbon resins have a low degree of unsaturation and high aromatic content, whereas some are highly unsaturated and yet some contain no aromatic structure at all. Differences in the resins are largely due to the olefins contained in the petroleum based feedstock from which the resins are derived. Conventional olefins for such resins include any C5 olefins (olefins and diolefins containing an average of five carbon atoms) such as, for example, cyclopentadiene, dicyclopentadiene, isoprene and piperylene, and any C9 olefins (olefins and diolefins containing an average of 9 carbon atoms) such as, for example, vinyltoluene and alphamethylstyrene. Such resins may be made from mixtures of such C5 and C9 olefins.

In one embodiment, said resin is a terpene resin. Such resin may be comprised of, for example, polymers of at least one of limonene, alpha pinene and beta pinene and having a softening point in a range of from about 60° C. to about 160° C.

In one embodiment, the resin is a terpene-phenol resin. Such terpene-phenol resin may be, for example, a copolymer of phenolic monomer with a terpene such as, for example, limonene and pinene.

In one embodiment, the resin is a resin derived from rosin and derivatives. Representative thereof are, for example, gum rosin and wood rosin. Gum rosin and wood rosin have similar compositions, although the amount of the components of the rosins may vary. Such resins may be in the form of esters of rosin acids and polyols such as pentaerythritol or glycol.

In one embodiment, said rosin resin may be partially or fully hydrogenated.

The precipitated silica reinforcement may, for example, be characterized by having a BET surface area, as measured using nitrogen gas, in the range of, for example, about 40 to about 600, and more usually in a range of about 50 to about 300 square meters per gram. The BET method of measuring surface area might be described, for example, in the Journal of the American Chemical Society, Volume 60, as well as ASTM D3037.

Such precipitated silicas may, for example, also be characterized by having a dibutylphthalate (DBP) absorption value, for example, in a range of about 100 to about 400, and more usually about 150 to about 300 cc/100 g.

Various commercially available precipitated silicas may be used, such as, and not intended to be limiting, silicas from PPG Industries under the Hi-Sil trademark with designations 210, 243, 315, etc.; silicas from Solvay with, for example, designations of Zeosil 1165MP and Zeosil 165GR; silicas from Evonik with, for example, designations VN2 and VN3; and chemically treated (pre-hydrophobated) precipitated silicas such as for example Agilon™ 400 from PPG.

Representative examples of rubber reinforcing carbon blacks are, for example, and not intended to be limiting, are referenced in The Vanderbilt Rubber Handbook, 13^{th} edition, year 1990, on Pages 417 and 418 with their ASTM designations. As indicated, such rubber reinforcing carbon blacks may have iodine absorptions ranging from, for example, 60 to 240 g/kg and DBP values ranging from 34 to 150 cc/100 g.

Representative of silica coupling agents for the precipitated silica are comprised of, for example;

(A) bis(3-trialkoxysilylalkyl) polysulfide containing an average in range of from about 2 to about 4, alternatively from about 2 to about 2.6 or from about 3.2 to about 3.8, sulfur atoms in its polysulfide connecting bridge, or

(B) an organoalkoxymercaptosilane, or

(C) their combination.

Representative of such bis(3-trialkoxysilylalkyl) polysulfide is comprised of bis(3-triethoxysilylpropyl) polysulfide.

It is readily understood by those having skill in the art that the vulcanizable rubber composition would be compounded by methods generally known in the rubber compounding art. In addition, said compositions could also contain fatty acid, zinc oxide, waxes, antioxidants, antiozonants and peptizing agents. Such fatty acids are typically basically carboxylic acids which may include, for example, stearic, palmitic, oleic acid and various mixtures thereof.

However, in one embodiment, rosin acid may be used instead of, and therefore to the substantial exclusion of, fatty carboxylic acids (e.g. a weight ratio of at least 6/1 and desirably at least 8/1 of rosin acid to fatty carboxylic acids and optionally without fatty carboxylic acids) in the rubber composition.

As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Usually it is desired that the sulfur-vulcanizing agent is elemental sulfur. The sulfur-vulcanizing agent may be used in an amount ranging, for example, from about 0.5 to 8 phr, with a range of from 1.2 to 6 phr being often more desirable. Typical amounts of processing aids for the rubber composition, where used, may comprise, for example, from about 1 to about 10 phr. Typical processing aids may be, for example, at least one of various fatty acids (e.g. at least one of palmitic, stearic and oleic acids) or fatty acid salts.

Rubber processing oils may be used, where desired, in an amount of, for example, from about 10 up to about 100, alternately from about 15 to about 45 phr, to aid in processing the uncured rubber composition. The processing oil used may include both extending oil contained in the production of the elastomers, and process oil freely added during blending of the elastomer with compounding ingredients. Suitable process oils include various oils as are known in the art, including aromatic, paraffinic, naphthenic, and low PCA oils, such as MES, TDAE, and heavy naphthenic oils, and vegetable (triglyceride based) oils such as, for example, sunflower, soybean, and safflower oils.

Therefore, in one embodiment, the rubber composition contains rubber processing oil comprised of:

(A) Triglyceride vegetable oil (e.g. comprised of at least one of sunflower, soybean and safflower oils), or

(B) Combination of triglyceride vegetable oil and petroleum based rubber processing oil.

Typical amounts of antioxidants may comprise, for example, about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants may comprise, for example, about 1 to 5 phr. Typical amounts of fatty acids, if used, which can include stearic acid comprise about 0.5 to about 5 phr. Typical amounts of zinc oxide may comprise, for example, about 2 to about 5 phr. Typical amounts of waxes comprise about 1 to about 5 phr. Often microcrystalline waxes are used. Typical amounts of peptizers, when used, may be used in amounts of, for example, about 0.1 to about 1 phr. Typical peptizers may be, for example, pentachlorothiophenol and dibenzamidodiphenyl disulfide.

Sulfur vulcanization accelerators are used to control the time and/or temperature required for vulcanization and to improve the properties of the vulcanizate. In one embodiment, a single accelerator system may be used, i.e., primary accelerator. The primary accelerator(s) may be used in total amounts ranging, for example, from about 0.5 to about 4, sometimes desirably about 0.8 to about 2.5, phr. In another embodiment, combinations of a primary and a secondary accelerator might be used with the secondary accelerator being used in smaller amounts, such as, for example, from about 0.05 to about 4 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, sulfenamides, and xanthates. Often desirably the primary accelerator is a sulfenamide. If a second accelerator is used, the secondary accelerator is often desirably a guanidine such as for example a diphenylguanidine.

The mixing of the vulcanizable rubber composition can be accomplished by methods known to those having skill in the rubber mixing art. For example, the ingredients are typically mixed in at least two stages, namely at least one non-productive stage followed by a productive mix stage. The final curatives, including sulfur-vulcanizing agents, are typically mixed in the final stage which is conventionally called the “productive” mix stage in which the mixing typically occurs at a temperature, or ultimate temperature, lower than the mix temperature(s) of the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

The pneumatic tire of the present invention may be, for example, a passenger tire, truck tire, a race tire, aircraft tire, agricultural tire, earthmover tire and off-the-road tire. Usually desirably the tire is a passenger or truck tire. The tire may also be a radial or bias ply tire, with a radial ply tire being usually desired.

Vulcanization of the pneumatic tire containing the tire tread of the present invention is generally carried out at conventional temperatures in a range of, for example, from about 125° C. to 200° C. Often it is desired that the vulcanization is conducted at temperatures ranging from about 135° C. to 180° C. Any of the usual vulcanization processes may be used such as heating in a press or mold, heating with superheated steam or hot air. Such tires can be built, shaped, molded and cured by various methods which are known and are readily apparent to those having skill in such art.

The following Examples are presented to further illustrate the invention. They are not intended to be limiting insofar as the breadth of the invention is concerned and their parts and percentages are by weight unless otherwise indicated.

### EXAMPLE I

### Preparation of Non-Functionalized and Functionalized High Vinyl Polybutadiene Elastomer

A 60 gallon (227 liter capacity) agitator containing jacketed reactor, having been dried and flushed with nitrogen, was charged with 210 pounds (95 kg) of a pre-dried 11.1 weight percent 1,3-butadiene solution in hexane. During agitation, the solution temperature was increased to 135° F. (57° C.) by application of heat to the reactor jacket.

To the agitated heated solution in the reactor was added 17.5 ml of TMEDA (tetramethylenediamine as a polymerization modifier) and 30 ml of dry hexane followed by addition of 36.6 ml of 15 weight percent n-butyl lithium polymerization catalyst (as a polymerization initiator) in hexane.

The temperature of the solution in the reactor was allowed to increase to 152° F. (67° C.), and after 1.5 hours, the content of the reactor was slowly transferred to a second vessel that had been pre-charged with 82.5 ml of 3,3-bis(triethoxysilylpropyl) polysulfide, which may be referred to as bis(3-triethoxysilylpropyl) polysulfide, having a range of about 2 to 2.6 connecting sulfur atoms in the polysulfidic bridge.

After 20 minutes of ageing, a polymerization stopping agent was added to stop the polymerization. The mixture was agitated for an additional 15 minutes to allow for the polymerization to discontinue

The resulting polymer product is an end functionalized polybutadiene elastomer recovered by removing the hexane by steam stripping.

The recovered product was a functionalized high Tg, high vinyl, polybutadiene elastomer determined to have a Tg of about −33° C. and a vinyl 1,2-isomeric content of about 70 percent with end-functional groups.

In a similar fashion, a non-functionalized version of a high Tg polybutadiene elastomer (Polymer B) was made in which the disulfide, the bis(3-triethoxysilylpropyl) polysulfide, was omitted from the polymerization reaction procedure. The recovered polymer product was a non-functionalized high Tg high vinyl polybutadiene elastomer determined to have a Tg of about −36° C. and a vinyl 1,2-isomeric content of about 69 percent.

### EXAMPLE II

This study was conducted to evaluate the comparative use of the functionalized, high Tg, high vinyl polybutadiene elastomer (Polymer A) prepared via Example I herein with the non-functionalized high Tg, high vinyl polybutadiene elastomer (Polymer B) also prepared in Example I.

In this Example, exemplary rubber compositions for a tire tread were prepared for evaluation for promoting a combination of wet traction and cold weather (winter) performance for a tire tread. Of further interest is the impact of functionalization of the polybutadiene elastomer on the laboratory determined properties of abrasion resistance and hysteresis that are predictive of treadwear and rolling resistance, respectively, of a tire tread.

A first control rubber composition (Sample X) was prepared as a precipitated silica reinforced rubber composition containing a combination of 38 phr of commercially available functionalized styrene/butadiene rubber having a Tg of about −23° C. and 62 phr of a commercially available functionalized low Tg, 12 per cent vinyl polybutadiene rubber having a Tg of about −90° C.

A second control rubber composition (Sample Y) was prepared as a precipitated silica reinforced rubber composition containing a combination of 38 phr of a non-functionalized high Tg high vinyl polybutadiene rubber (Polymer B from Example I herein) having a Tg of about −36° C. and 62 phr of a functionalized low Tg, low vinyl polybutadiene rubber having a Tg of about −90° C. The second control rubber composition (Sample Y) is similar to the first control rubber composition (Sample X), except the commercially available functionalized styrene/butadiene rubber is replaced with a non-functionalized high vinyl polybutadiene rubber (Polymer B).

An Experimental rubber composition (Sample Z) was prepared as a precipitated silica reinforced rubber composition containing a combination of 38 phr of a functionalized high Tg, high vinyl polybutadiene rubber (Polymer A from Example I herein) having a Tg of about −33° C. and 62 phr of a functionalized low Tg, low vinyl polybutadiene rubber having a Tg of about −90° C. This experimental rubber composition is similar to Sample Y except that the high vinyl polybutadiene rubber (Polymer A) is a functionalized polybutadiene elastomer.

The rubber compositions are illustrated in the following Table 1.

TABLE 1

| | Parts by Weight (phr) | | |
|---|---|---|---|
| | Control | Control | Exp'1 |
| Material | Sample X | Sample Y | Sample Z |
| Functionalized styrene/butadiene | 38 | 0 | 0 |
| rubber¹ | | | |
| Functionalized low vinyl | 62 | 62 | 62 |
| polybutadiene² | | | |
| High vinyl polybutadiene³ | 0 | 38 | 0 |
| Functionalized high vinyl | 0 | 0 | 38 |
| polybutadiene⁴ | | | |
| Precipitated silica⁵ | 80 | 80 | 80 |
| Silica coupler⁶ | 6.4 | 6.4 | 6.4 |
| Rubber processing oil, fatty acids | 30 | 30 | 30 |
| and waxes⁷ | | | |
| Antidegradants | 3 | 3 | 3 |
| Carbon black (N330) | 10 | 10 | 10 |
| Cure system: zinc oxide, sulfur, | 7 | 7 | 7 |
| accelerators⁸ | | | |

¹Functionalized styrene/butadiene rubber having a styrene content of about 20 percent and a vinyl content of about 50 percent with a Tg of about −26° C. as Sprintan 4602 from Trinseo understood to be end functionalized with functional groups comprised of siloxane and thiol groups reactive with hydroxyl groups on precipitated silica
²Functionalized low vinyl (12 percent) polybutadiene rubber as BR1261 from Zeon having a Tg of about −92° C. and functional groups reactive with hydroxyl groups on precipitated silica
³Non functionalized high Tg, high vinyl polybutadiene elastomer as Polymer B prepared in Example I
⁴Functionalized high Tg, high vinyl polybutadiene elastomer as Polymer A prepared in Example I
⁵Precipitated silica as Zeosil 1165MP from Solvay
⁶Silica coupler comprised of a bis(3-triethoxysilylpropyl) polysulfide containing an average in a range of from about 2 to about 2.6 connecting sulfur atoms in its polysulfidic bridge as Si266 from Evonik
⁷Rubber processing oil, fatty acids containing stearic, palmitic and oleic acids and waxes comprised of paraffinic and microcrystalline waxes
⁸Zinc oxide, sulfur and sulfur cure accelerators as sulfenamide primary accelerator and diphenyl guanidine secondary accelerator

The rubber Samples were prepared by blending the ingredients, other than the sulfur curatives, in a first non-productive mixing stage (NP1) in an internal rubber mixer for about four minutes to a temperature of about 160° C. The resulting mixtures were subsequently individually mixed in a second sequential non-productive mixing stage (NP2) in an internal rubber mixer for about three minutes to a temperature of about 160° C. The rubber compositions were subsequently mixed in a productive mixing stage (P) in an internal rubber mixer with the sulfur curatives comprised of the sulfur and sulfur cure accelerators for about two minutes to a temperature of about 115° C. The rubber compositions were each removed from the internal mixer after each non-productive mixing step and cooled to below 40° C. before the final productive mixing stage.

The following Table 2 illustrates cure behavior and various physical properties of rubber compositions based upon the basic formulation of Table 1 and reported herein as first Control rubber Sample X, second Control rubber sample Y and Experimental rubber Sample Z. Where cured rubber samples are reported, such as for the stress-strain, hot rebound and hardness values, the rubber samples were cured for about 14 minutes at a temperature of about 160° C.

To evaluate the predictive wet traction, a tangent delta (tan delta) test was run at 0° C.

To evaluate the predictive low temperature performance (e.g. winter and snow conditions) performance, the rubber's storage modulus E′ physical property (a measure of its stiffness) was determined at −20° C. to provide a stiffness value of the rubber composition at lower ambient temperatures.

TABLE 2

| | Parts by Weight (phr) | | |
|---|---|---|---|
| | Control | Control | Exp'1 |
| Material | Sample X | Sample Y | Sample Z |
| Functionalized styrene/butadiene | 38 | 0 | 0 |
| rubber | | | |
| Functionalized low Tg, low vinyl | 62 | 62 | 62 |
| polybutadiene | | | |
| Non-functionalized high Tg, high | 0 | 38 | 0 |
| vinyl polybutadiene | | | |
| rubber (Polymer B) | | | |
| Functionalized high Tg, high vinyl | 0 | 0 | 38 |
| polybutadiene rubber (Polymer A) | | | |
| Cured Properties | | | |
| Wet Traction Laboratory Prediction | | | |
| Tan delta at 0° C. (higher is better) | 0.15 | 0.13 | 0.13 |
| Cold Weather (Winter) Performance | | | |
| (Stiffness) Laboratory Prediction | | | |
| Storage modulus (E'), (MPa) at | 9.7 | 8.7 | 5.9 |
| −20° C., 10 Hertz, 0.25% strain | | | |
| (lower stiffness values are better) | | | |
| Rolling Resistance (RR) Laboratory | | | |
| Prediction | | | |
| Rebound at 100° C., percent | 64 | 64 | 66 |
| Additional properties | | | |
| Tensile strength (MPa) | 18 | 17 | 15 |
| Elongation at break (%) | 367 | 361 | 327 |
| Modulus 300% (MPa) | 14 | 13 | 14 |
| DIN abrasion loss, cc (lower is | 59 | 58 | 54 |
| better)¹ | | | |

¹DN53516, relative volume loss (relative to a control)

From Table 2 it is observed that:

(A) Experimental Sample Z has a predictive wet traction based on its tan delta property at 0° C. of 0.13 which is similar to Control Samples Y and X.

(B) Experimental Sample Z has a predictive rolling resistance for a tire tread of such rubber composition, based on hot rebound property at 100° C. of 66, which is beneficially better than the hot rebound properties of Control Samples X and Y which have hot rebound values of 64.

(C) Experimental Sample Z has a DIN abrasion wear resistance value of 54 which is an improvement over the values of 58 for Control Sample Y and 59 for Control Sample X.

(D) Experimental Sample Z has a predictive winter (cold weather) performance based on its stiffness value (E′) at −20° C. of 5.9 which is a significant improvement over the values of 8.7 for Control Sample Y and 9.7 for Control Sample X.

Therefore, it is concluded that the replacement of a functionalized high Tg styrene/butadiene rubber with a functionalized high Tg, high vinyl polybutadiene rubber in a blend with a functionalized low vinyl, low Tg, low vinyl polybutadiene rubber for a silica reinforced tread composition will provide similar wet traction and improvements in winter performance, rolling resistance and treadwear based on laboratory determined predictive properties. It is also demonstrated that a non-functionalized high Tg, high vinyl polybutadiene rubber will also improve winter performance, but without improvement in predictive treadwear and rolling resistance for a tire tread. It is also observed that the predictive improvement of winter performance of the non-functionalized high Tg, high vinyl polybutadiene rubber is further improved when compared to a functionalized version of the same polymer as the stiffness value at −20° C. is lowered from 8.7 to 5.9. This lowering of stiffness is a key discovery of this functionalized rubber.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire having a circumferential rubber tread of a rubber composition containing precipitated silica reinforcement comprised of, based on parts by weight per 100 parts by weight elastomer (phr):
(A) 100 phr of conjugated diene-based elastomers comprised of;
(1) about 20 to about 80 phr of a functionalized high Tg, high vinyl polybutadiene rubber having a Tg in a range of from about −40° C. to about −10° C. and an isomeric vinyl 1,2-content in a range of from about 65 to about 85 percent, where said functionalized high vinyl polybutadiene rubber contains functional groups reactive with hydroxyl groups on said precipitated silica reinforcement,
(2) about 80 to about 20 phr of a functionalized low Tg, low vinyl polybutadiene rubber having a Tg in a range of from about −108° C. to about −90° C. and an isomeric vinyl 1,2-content in a range of from about 0 to about 15 percent, where said functionalized low vinyl polybutadiene rubber contains functional groups reactive with hydroxyl groups on said precipitated silica reinforcement, provided that the weight ratio of low vinyl to high vinyl functionalized polybutadiene rubber is at least 1/1 and alternately at least 1.5/1,
(B) about 60 to about 200 phr of rubber reinforcing filler comprised of a combination of precipitated silica (amorphous synthetic precipitated silica) and rubber reinforcing carbon black in a weight ratio of precipitated silica to rubber reinforcing carbon black of at least 9/1, together with a silica coupling agent having a moiety reactive with hydroxyl groups (e.g. silanol groups) on said precipitated silica and another different moiety interactive with said diene-based elastomers, and
(C) zero to about 60 phr of a traction promoting resin comprised of at least one of styrene-alphamethylstyrene resin, coumarone-indene resin, petroleum hydrocarbon resin, terpene polymer, terpene phenol resin, rosin derived resin and copolymers.

2. The tire of claim 1 wherein, for said tread rubber composition, said-end functionalized high vinyl polybutadiene elastomers is the polymerization product of 1,3-butadiene monomer end-functionalized by a functionalized polymerization initiator.

3. The tire of claim 1 wherein, for said tread rubber composition, said end-functionalized high vinyl polybutadiene elastomers is the polymerization product of 1,3-butadiene monomer end-functionalized by a functionalized polymerization terminator.

4. The tire of claim 1 wherein, for said tread rubber composition, is at least one of end-functionalized high vinyl polybutadiene elastomers is a bi-functionalized high vinyl polybutadiene elastomer and is the polymerization product of 1,3-butadiene monomer end-functionalized by a combination of functionalized polymerization initiator and polymerization terminator.

5. The tire of claim 1 wherein, for said tread rubber composition, said functional high vinyl and low vinyl polybutadiene elastomers contain at least one functional group reactive with hydroxyl groups on said precipitated silica comprised of:
(A) Amine functional group reactive with hydroxyl groups on said precipitated silica,
(B) Siloxy functional group reactive with hydroxyl groups on said precipitated silica,
(C) Combination of amine and siloxy groups reactive with hydroxyl groups on said precipitated silica,
(D) Combination of siloxy and thiol groups reactive with hydroxyl groups on said precipitated silica,
(E) Combination of imine and siloxy groups reactive with hydroxyl groups on said precipitated silica,
(F) Hydroxyl functional groups reactive with said precipitated silica,
(G) Epoxy groups reactive with hydroxyl groups on said precipitated silica,
(H) Carboxyl groups reactive with hydroxyl groups on said precipitated silica, and
(I) Alkyl or Aryl silylamine groups reactive with hydroxyl groups on said precipitated silica.

6. The tire of claim 1 wherein said tread rubber composition further contains up to about 25 phr of at least one additional diene based elastomer exclusive of styrene containing elastomers.

7. The tire of claim 1 wherein said tread rubber composition further contains up to about 15 phr of at least one of cis 1,4-polyisoprene and copolymers of isoprene and butadiene.

8. The tire of claim 1 wherein said precipitated silica is provided as a composite of pre-reacted precipitated silica and silica coupling agent prior to addition to the rubber composition.

9. The tire of claim 1 wherein said precipitated silica is a product of precipitated silica and silica coupling agent reacted in situ within the rubber composition.

10. The tire of claim 1 wherein said silica coupling agent is comprised of:
(A) bis(3-trialkoxysilylalkyl) polysulfide containing an average in range of from about 2 to about 4 sulfur atoms in its polysulfide connecting bridge, or
(B) an organoalkoxymercaptosilane, or
(C) their combination.

11. The tire of claim 1 wherein said silica coupling agent is comprised of a bis(3-triethoxysilylpropyl) polysulfide.

12. The tire of claim 1 wherein said silica coupling agent is comprised of a bis(3-triethoxysilylpropyl) polysulfide containing an average of from about 2 to about 2.6 sulfur atoms in its polysulfidic bridge.

13. The tire of claim 1 wherein said silica coupling agent is comprised of an organoalkoxymercaptosilane.

14. The tire of claim 1 wherein said tread rubber composition contains traction promoting resin comprised of at least one of styrene/alphamethylstyrene resin, coumarone-indene resin, petroleum hydrocarbon resin, terpene polymer, terpene phenol resin and rosin derived resin and copolymers thereof and hydrogenated rosin acid.

15. The tire of claim 1 where said tread rubber composition contains rosin acid to the substantial exclusion of fatty carboxylic acids.

16. The tire of claim 1 where said tread rubber composition contains rubber processing oil comprised of triglyceride based vegetable oil.

17. The tire of claim 15 where said tread rubber composition contains rubber processing oil comprised of triglyceride based vegetable oil.

18. The tire of claim 1 where said rubber composition contains rubber processing oils as a combination of triglyceride vegetable oil and petroleum based oil.

19. The tire of claim 1 wherein said tread rubber composition is sulfur cured.

20. The tire of claim 2 wherein said tread rubber composition is sulfur cured.
